(19) United States
(12) Patent Application Publication
(10) Pub. No.: US 2009/0115141 A1
(43) Pub. Date: May 7, 2009

(54) Stage one nozzle to transition piece seal

(75) Inventor: Scott R. Simmons, Greenville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/979,676

(22) Filed: Nov. 7, 2007

(51) Int. Cl. F16J 15/02

(52) U.S. Cl. 277/630; 60/804

(57) ABSTRACT

A transition piece seal assembly for sealing an interface between at least one transition piece extending between a turbine combustor and a first stage turbine nozzle. The seal assembly includes an aft frame having on a first axial side thereof at least one axially projecting can shaped receptacle for axially receiving an aft end of a transition piece and a generally planar mounting surface on a second axial side thereof for being disposed in opposed facing relation to the first stage nozzle; and at least one resilient seal element disposed on an inner peripheral surface of the can shape receptacle so as to be disposed between the transition piece aft end and the can shaped receptacle.

### BACKGROUND OF THE INVENTION

This invention relates to seals for turbine applications and particularly to seals between combustor transition pieces and turbine stage one nozzle.

Sealing is oftentimes essential in rotary machines, especially when there are two relatively movable mechanical members in close proximity to one another. For example, sealing is required to prevent or at least minimize leakage of combustion gases at the interface between combustor transition pieces and stage one nozzles of gas turbines.

In can-annular combustor arrangements typically found in gas turbines manufactured by the assignee, a plurality of combustors are disposed in an annular array about the axis of the turbine. Hot combustion gases flow from each combustor through a respective transition piece into the first stage nozzle. In addition to relative movement due, e.g., to dynamic pulsing between these components, the transition pieces and first stage nozzle are formed of different materials and are subjected to different temperatures during operation, thereby experiencing different degrees of thermal growth. Thus, both the transition pieces and the first stage nozzle and/or nozzle support elements may move radially, circumferentially and axially relative to one another. This “mismatch” at the interface of the transition pieces and the first stage nozzle and/or nozzle support elements requires an effective seal to contain the combustion products and the pressure differential across that interface, and to prevent compressor discharge air from bypassing the combustor.

It is known to employ a dual stiffness cloth brush seal for sealing between combustor transition pieces and first stage nozzles or nozzle supports. Specifically, the layers of cloth material are disposed in a frame and suitably secured thereto, for example, by clamping to the frame, welding the material to the frame, or the like. The free edge of the layers are engaged within a U-shaped channel extending about the periphery of the downstream end of each transition piece, while a seal support is mounted within a groove or slot formed in the first stage nozzle or nozzle support. A cloth brush seal of this type is disclosed in commonly owned U.S. Pat. No. 6,042,119. This seal is not completely effective, however. For example, the inner and outer side walls of the stage one nozzle are unevenly heated, due to varied velocities on the pressure and suction sides of the nozzle. This causes the groove or slot where the seal support is secured to unevenly distort. This distortion, in effect, lifts the transition piece seal off its pressure sealing surface in the groove or slot, causing compressor discharge air to bypass the combustor, thereby increasing the levels of NOx emitted to atmosphere.

Commonly owned U.S. Pat. No. 6,547,257 seeks to minimize leakage by combining the transition piece seal with flexible spring seal elements that provide better leakage control at the interface of the transition piece and the stage one nozzle or nozzle support.

Specifically, each flexible spring seal element of the '257 patent includes a generally horizontal mounting flange that enables the spring seal element to be secured within the slot formed in the first stage nozzle, along with the transition piece seal support. The remainder of the spring seal element has a sideways S or Z shape, with a flexible free end of the seal element adapted to engage the forward face of the first stage nozzle. The spring seal element is formed with a plurality of laterally spaced, axially oriented slots extending from the free sealing edge substantially to the horizontal mounting flange so that the spring seal element can differentially adapt or conform to the forward face of the first stage nozzle. To prevent leakage through the slots, a second substantially identical spring seal element is layered over the first spring seal element, but laterally offset in a shingled arrangement, thereby closing the slots in the respective spring elements. When the spring seal elements are mounted in the groove or slot in the first stage nozzle, along with the transition piece seal support, the free ends of the spring seal elements are resiliently compressed or biased against the forward face of the stage one nozzle, creating a first sealing location. At the same time, axial compression of the sealing elements also results in a downward force on the mounting flange, pushing the transition piece seal support against the lower surface of the groove or slot in the first stage nozzle, creating a second seal location.

However, the '257 design is not without potential deficiencies. In this regard, the spring seal element is vulnerable to assembly and operational damage, such as damage from excessive compression on relative movement of the component parts. In addition, unintended leakage around the seal is predicted to be 1.7 times the actual planned cooling through the aft frame holes. Also, the aft frame weld can compromise transition piece reliability and the side scoops provided according to that design cause a high thermal gradient resulting in increased reliability risk.

### BRIEF DESCRIPTION OF THE INVENTION

The invention may be embodied in a transition piece seal assembly for sealing an interface between at least one transition piece extending between a turbine combustor and a first stage turbine nozzle, comprising: an aft frame having on a first axial side thereof at least one axially projecting can shaped receptacle for axially receiving an aft end of a transition piece and a generally planar mounting surface on a second axial side thereof for being disposed in opposed facing relation to the first stage nozzle; and at least one resilient seal element disposed on an inner peripheral surface of said can shape receptacle so as to be disposed between said transition piece aft end and said can shaped receptacle.

The invention may also be embodied in a gas turbine comprising an annular array of combustors, each having a transition piece extending between the combustor and a first stage turbine nozzle, and wherein a transition piece seal assembly is interposed at the inner face of each transition piece and the first stage turbine nozzle, each transition piece seal assembly comprising: an aft frame having on a first axial side thereof at least one axially projecting can shaped receptacle for axially receiving an aft end of a transition piece and a generally planar mounting surface on a second axial side thereof for being disposed in opposed facing relation to the first stage nozzle; and at least one resilient seal element disposed on an inner peripheral surface of said can shape receptacle so as to be disposed between said transition piece aft end and said can shaped receptacle.

The invention may further be embodied in a method of controlling leakage at an interface of a transition piece and a first stage turbine nozzle, wherein the transition piece extends between a combustor and the first stage turbine nozzle, the method comprising: a) providing a transition piece seal assembly between the transition piece and the first stage turbine nozzle, wherein the transition piece seal assembly is supported on a forward face of the first stage turbine nozzle and includes an aft frame having on a first axial side thereof at least one axially projecting can shaped receptacle for axially receiving an aft end of a transition piece and a generally planar mounting surface on a second axial side thereof for being disposed in opposed facing relation to the first stage nozzle, and at least one resilient seal element disposed on an inner peripheral surface of said can shape receptacle; and b) inserting an aft end of a transition piece into each said can shaped receptacle with so that said seal element is disposed radially between said transition piece aft end and said can shaped receptacle.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a schematic cross-sectional view of a first stage nozzle to transition piece seal embodying the invention;

FIG. 2 is a perspective view of an aft frame segment mounted to a corresponding portion of the first stage nozzle assembly according to an embodiment of the invention;

FIG. 3 is a detail of the noted section of FIG. 2;

FIG. 4 is a perspective view of the assembly of FIG. 2, taken from the nozzle side;

FIG. 5 is a perspective view of a portion of an aft frame segment illustrating a seal structure disposed therewithin;

FIG. 6 is a detail of the noted section of FIG. 5; and

FIG. 7 is a perspective view illustrating transition piece parts assembled to an aft frame segment in an embodiment of the invention;

### DETAILED DESCRIPTION OF THE INVENTION

This invention is a sealing design for the combustion to turbine hot gas path components. It connects the combustion transition piece to the turbine first stage nozzle. Significant leakage occurs at this joint due to the need to allow for relative motion between the nozzle and transition piece due to transient thermal distortion. This leakage leads to higher NOx emissions and variation in air flow from combustor to combustor.

The seal between the stage one nozzle and transition piece must (1) allow for cooling of the hot gas path parts, (2) allow for relative motion, (3) minimize leakage, and (4) transition from discrete cylindrical flow (can) to annular flow (360° annulus). To date, this function has been accomplished by a welded aft frame on the back of the combustor transition piece and a multitude of flexible seals on the top, bottom and sides of the joint.

The concept of the invention is embodied in the separation of design functions by having an aft frame that is “can” on one side and “annular” on the other side. In an embodiment of the invention, the transition from discrete cylindrical flow (can) to annular flow is achieved by making an aft frame having one side conforming to a discrete can geometry and the other side conforming to a continuous annular geometry. This allows the combustion transition piece to aft frame sealing to be optimized for cooling, relative motion and low leakage in discrete can sections. The aft frame to stage one nozzle seal can be optimized for low leakage and cooling in a continuous annular configuration.

In an embodiment of the invention, a transition piece seal to first stage nozzle is provided that, as compared to conventional seal structures, reduces sealing assembly complexity and cost, and reduces leakage amount and variation while still allowing necessary cooling. As noted, the seal structure of the invention allows for transition piece and stage one nozzle relative movement during thermal transients without causing leakage/cooling variation and transitions effectively from discrete cylindrical flow (can) to annular flow.

Thus, a transition piece seal assembly is provided according to an example embodiment of the invention that defines can receptacles on one axial side thereof, each for axially slidably receiving a respective transition piece. The other side of the seal assembly defines a flat, planar mounting surface for being abutted to and secured against the turbine stage one nozzle. The flat planar mounting surface extends peripherally around each opening through the seal assembly defined by the can on the upstream side to effectively transition from a can configuration on the transition piece side of the seal assembly to the annular configuration on the tubular stage one nozzle side.

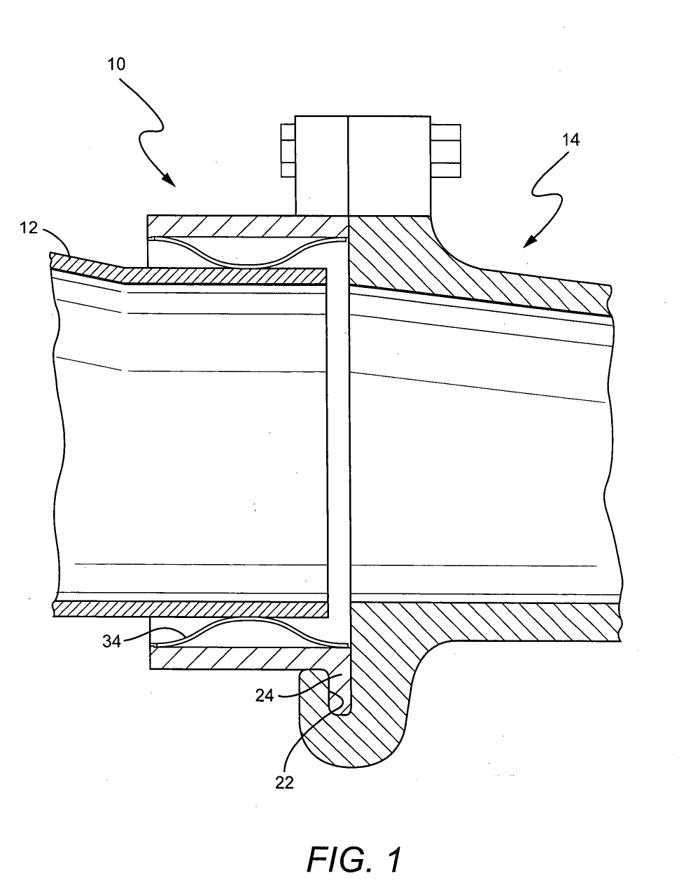

As illustrated in FIGS. 1, 2 and 4, in particular, an aft frame 10 is provided to transition from the can configuration of the transition pieces 12 to the annulus defined by the first stage nozzle 14. In the illustrated example embodiment, the aft frame is comprised of a plurality of aft frame segments 16. In the illustrated example, each aft frame segment 16 includes first and second C-shaped can parts 18, 20 which, when, respectively mated with a next adjacent C-shaped can part defines a can shaped receptacle for receiving the aft end of a respective transition piece 12.

A groove 22 is defined about the nozzle 14 inner diameter which extends annularly about the turbine structure. Each aft frame segment 16 includes a downwardly depending flange 24 configured to be hooked into the groove 22 of the nozzle inner diameter. As each aft frame segment 16 is hooked into the nozzle inner diameter, the aft frame segment may then be slid to engage a next adjacent aft frame segment.

As illustrated in FIGS. 3 and 6, in this example embodiment, one circumferential side edge of the aft frame segment 16 includes, at the end of one the C-shaped can parts 18, an axially extending tongue 26 that projects in the circumferential direction of the aft frame 10. The other of the C-shaped can parts 20 includes an axially extending groove 28 that is recessed in the circumferential direction of the aft frame 10 for receiving the tongue 26 of a next adjacent can part 18. Thus, each aft frame segment 16 may be slid to the left or to the right to fit the tongue 26 into the groove 28 of the next adjacent aft frame segment 16. In this example embodiment, the last two aft frame segments have grooves on both circumferential sides to ease assembly. Where grooves of can parts of aft frame segments face one another locking inserts are provided to complete the assembly. The new aft frame is proposed to be formed from stainless steel.

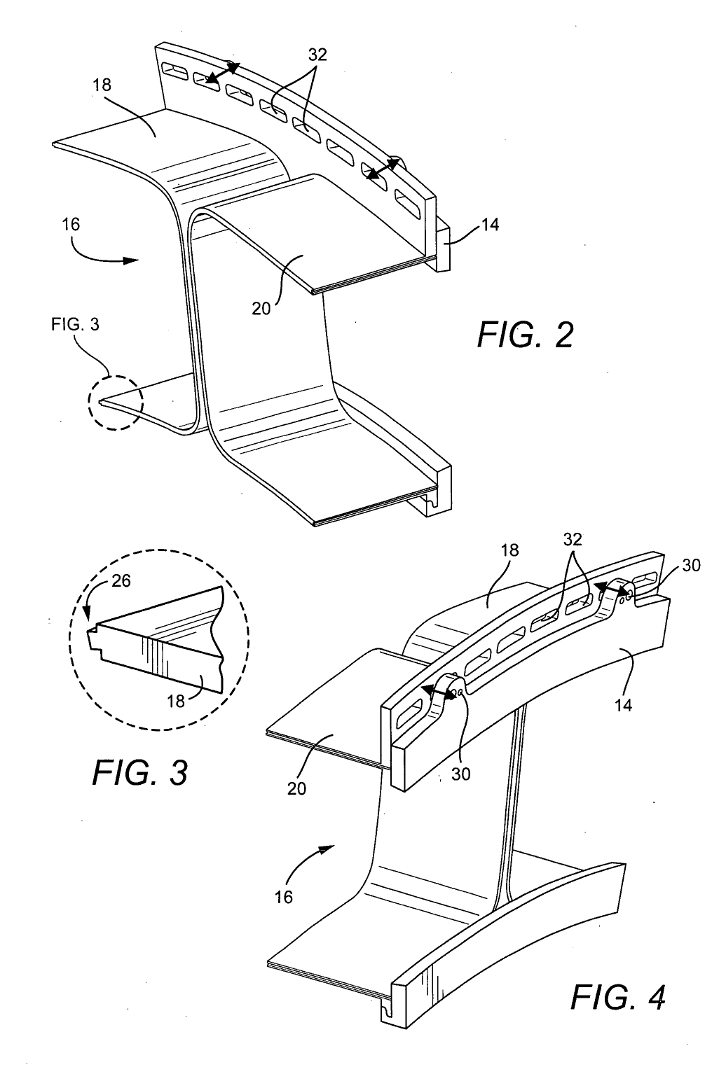

As illustrated in FIGS. 1 and 4, bolt holes 30 are defined at spaced locations about the nozzle 14 outer diameter for bolting the radially outer periphery of the aft frame segments in position. A plurality of holes or slots 32 for receiving such bolts are provided in the aft frame segment as illustrated in FIGS. 2 and 4. Although using bolts is a manufacturing-friendly way to securely fasten at the outer ring, any fastening device and/or technique which allows assembly as described and results in a tight seal would be an acceptable alternative.

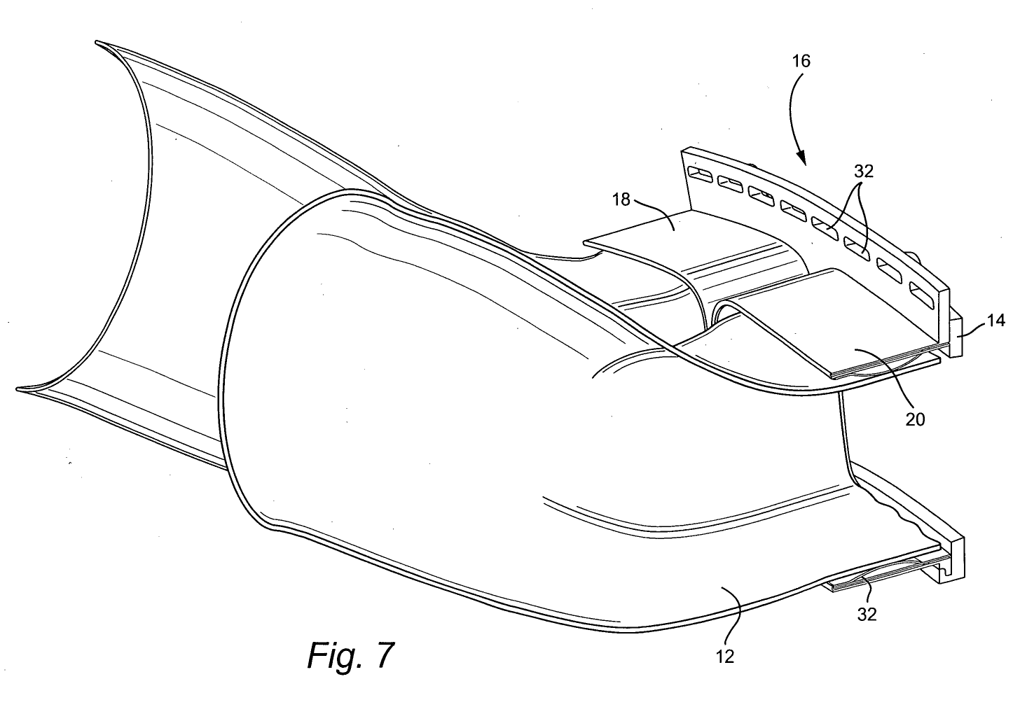

A resilient seal element is disposed between the transition piece liner 12 and the aft frame 10. According to one example embodiment, as illustrated in FIGS. 1, 5 and 7, the resilient seal element is a hula seal 34 that is disposed between the transition piece liner 12 and the aft frame 10. This seal allows for relative movement between the first stage nozzle and transition piece without causing leakage or cooling variation. In this example embodiment, the seal assembly is essentially two modified 180° hula seals welded to a single fabricated aft frame segment.

As noted above, the '257 leaf spring design is vulnerable to thermal and mechanical distortion. The hula seal 34 provided in the illustrated example embodiment of the invention allows axial relative movement without being vulnerable to thermal or mechanical distortion.

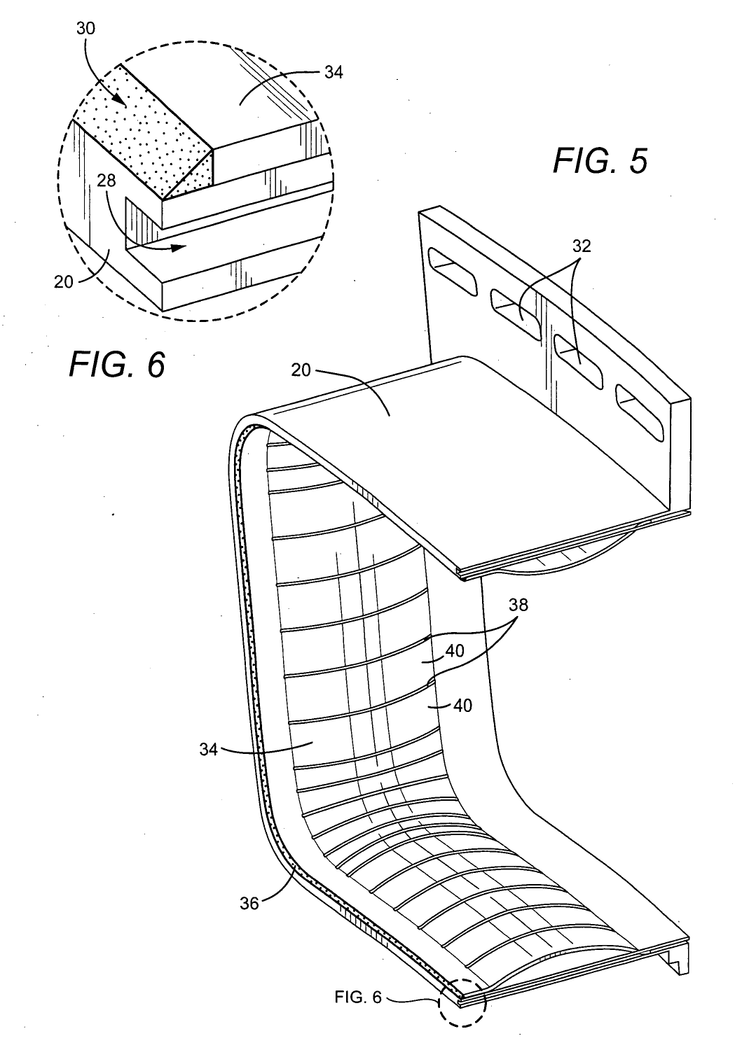

The hula seal is welded as at 36 to the aft frame C-shaped can parts 18, 20 to fix its forward end whereas its aft end is free to deflect. As illustrated, the hula seal is slotted as at 38. The slots 38 extend to the aft end of the seal material but spaced from the leading end to define a plurality of independent flex parts 40. As shown in FIG. 5, the segments are roughly twice as narrow around the corners to allow for bending deformation. Although a single hula seal is illustrated, a double hula seal version may be useful as well. It is also to be understood that some other type(s) of resilient seal elements, such as, for example, brush seals, could be used. Indeed, the inventive concept is not limited to the particular type of resilient seal element.

Excluding bolts, the two new seals replace four assemblies of the '257 design: inner seal, outer seal, and two side seal assemblies (not shown in the '257 patent), resulting in a part count reduction from about 25 to 2.

As noted above, the aft frame segments 16 hook into the stage one nozzle slot or groove 22 and rotate forward to be bolted onto the nozzle 14 flange. The combustor transition piece 12 then slides axially into place as normal.

While the invention has been described in connection with what is presently considered to be, the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A transition piece seal assembly for sealing an interface between at least one transition piece extending between a turbine combustor and a first stage turbine nozzle, comprising:
an aft frame having on a first axial side thereof at least one axially projecting can shaped receptacle for axially receiving an aft end of a transition piece and a generally planar mounting surface on a second axial side thereof for being disposed in opposed facing relation to the first stage nozzle; and
at least one resilient seal element disposed on an inner peripheral surface of said can shape receptacle so as to be disposed between said transition piece aft end and said can shaped receptacle.

2. A transition piece seal assembly as in claim 1, wherein said mounting surface is defined about a periphery of an opening through said aft frame corresponding to said can shaped receptacle.

3. A transition piece seal assembly as in claim 1, wherein said aft frame includes a plurality of apertures for receiving fastening devices to secure said aft frame to said first stage nozzle.

4. A transition piece seal assembly as in claim 1, wherein said aft frame comprises a plurality of aft frame segments, each said aft frame segment including first and second C-shaped can parts so that mutually adjacent aft frame segments together define each said can shaped receptacle.

5. A transition piece seal assembly as in claim 4, wherein a circumferentially facing axially extending side edge of one of said C-shaped can parts comprises a groove.

6. A transition piece seal assembly as in claim 5, wherein a circumferentially facing axially extending side edge of the other of said C-shaped parts comprises a projection for engaging a circumferentially facing axially extending groove of a next adjacent C-shaped can part.

7. A transition piece seal assembly as in claim 4, wherein a groove is defined about the nozzle inner diameter to extend annularly about the turbine structure and wherein each aft frame segment includes a downwardly depending flange configured to be hooked into the groove of the nozzle inner diameter, whereby each aft frame segment can be hooked into the nozzle inner diameter groove and then circumferentially displaced to engage a next adjacent aft frame segment.

8. A transition piece seal assembly as in claim 7, wherein a circumferentially facing axially extending side edge of one of said C-shaped can parts comprises a groove, and a circumferentially facing axially extending side edge of the other of said C-shaped parts comprises a projection for engaging a circumferentially facing axially extending groove of a next adjacent C-shaped can part.

9. A transition piece seal assembly as in claim 1, wherein said resilient seal element comprises at least one hula seal.

10. A transition piece seal assembly as in claim 9, wherein an upstream end of said hula seal with respect to a flow of hot combustion gases through the aft frame is welded to said can shaped receptacle.

11. A transition piece seal assembly as in claim 10, wherein the hula seal is slotted, said slots being spaced from the welded upstream end and extending to the aft end of the seal material to define a plurality of flex parts.

12. A transition piece seal assembly as in claim 11, wherein can shaped receptacle comprises generally straight radially inner and outer walls and generally straight side walls, said can shaped receptacle being curved at corners between said straight walls.

13. A transition piece seal assembly as in claim 12, wherein the segments defined by said slots are about twice as narrow at said corners of said can shaped receptacle as compared to straight walls of the can shaped receptacle.

14. A gas turbine comprising an annular array of combustors, each having a transition piece extending between the combustor and a first stage turbine nozzle, and wherein a transition piece seal assembly is interposed at the inner face of each transition piece and the first stage turbine nozzle, each transition piece seal assembly comprising:
an aft frame having on a first axial side thereof at least one axially projecting can shaped receptacle for axially receiving an aft end of a transition piece and a generally planar mounting surface on a second axial side thereof for being disposed in opposed facing relation to the first stage nozzle; and
at least one resilient seal element disposed on an inner peripheral surface of said can shape receptacle so as to be disposed between said transition piece aft end and said can shaped receptacle.

15. A gas turbine as in claim 14, wherein said aft frame comprises a plurality of aft frame segments, each said aft frame segment including first and second C-shaped can parts so that mutually adjacent aft frame segments together define each said can shaped receptacle.

16. A gas turbine as in claim 15, wherein a groove is defined about the nozzle inner diameter to extend annularly about the turbine structure and wherein each aft frame segment includes a downwardly depending flange configured to be hooked into the groove of the nozzle inner diameter, whereby each aft frame segment can be hooked into the nozzle inner diameter groove and then circumferentially displaced to engage a next adjacent aft frame segment.

17. A gas turbine as in claim 16, wherein a circumferentially facing axially extending side edge of one of said C-shaped can parts comprises a groove, and a circumferentially facing axially extending side edge of the other of said C-shaped parts comprises a projection for engaging a circumferentially facing axially extending groove of a next adjacent C-shaped can part.

18. A gas turbine as in claim 14, wherein said resilient seal element comprises at least one hula seal, wherein an upstream end of said hula seal, with respect to a flow of hot combustion gases through the aft frame, is welded to said can shaped receptacle, and wherein the at least one hula seal is slotted, said slots being spaced from the welded upstream end and extending to the aft end of the seal material to define a plurality of flex parts.

19. A method of controlling leakage at an interface of a transition piece and a first stage turbine nozzle, wherein the transition piece extends between a combustor and the first stage turbine nozzle, the method comprising:
a) providing a transition piece seal assembly between the transition piece and the first stage turbine nozzle, wherein the transition piece seal assembly is supported on a forward face of the first stage turbine nozzle and includes an aft frame having on a first axial side thereof at least one axially projecting can shaped receptacle for axially receiving an aft end of a transition piece and a generally planar mounting surface on a second axial side thereof for being disposed in opposed facing relation to the first stage nozzle, and at least one resilient seal element disposed on an inner peripheral surface of said can shape receptacle; and
b) inserting an aft end of a transition piece into each said can shaped receptacle with so that said seal element is disposed radially between said transition piece aft end and said can shaped receptacle.

20. A method as in claim 19, wherein said aft frame comprises a plurality of aft frame segments, each said aft frame segment including first and second C-shaped can parts so that mutually adjacent aft frame segments together define each said can shaped receptacle, wherein a groove is defined about the nozzle inner diameter to extend annularly about the turbine structure, and wherein each aft frame segment includes a downwardly depending flange configured to be hooked into the groove of the nozzle inner diameter, whereby each aft frame segment is hooked into the nozzle inner diameter groove and then circumferentially displaced to engage a next adjacent aft frame segment.
